(19) United States
(12) Patent Application Publication
(10) Pub. No.: US 2005/0230374 A1
(43) Pub. Date: Oct. 20, 2005

(54) Multi-architecture flexible assembly structure and method

(76) Inventors: Kenneth A. Rapp, Brownstown Twp., MI (US); Fernando A. Olave, Livonia, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 10/827,856

(22) Filed: Apr. 20, 2004

(51) Int. Cl. B23K 11/36

(52) U.S. Cl. 219/158

(57) ABSTRACT

A multi-architecture flexible assembly structure includes transfer devices, and programmable loading structures, work fixtures, and unloading structures for assembling components into selected different styles of finished assemblies.

### FIELD OF THE INVENTION

The invention relates to an assembly structure and more particularly to a multi-architecture flexible assembly structure including programmable conveying devices, programmable fixture devices, and programmable welding devices.

### BACKGROUND OF THE INVENTION

In the current vehicle market, there exists a variety of body shapes, sizes, styles, and configurations to meet consumer demand. Typically, manufacturing facilities are limited in the types of vehicles which may be manufactured due to different vehicle configurations for different vehicle types. Compact cars and luxury cars, for example, require substantially different body panel sizes, shapes, and in some cases require different quantities of body panels.

A vehicle manufacturing facility typically includes a tooling system that has been mechanically and electrically designed to produce variations of a single vehicle architecture. Changeover to a different body architecture requires that the tooling system be reconfigured, reprogrammed, and in some cases completely replaced, resulting in substantial changeover delays and long startup times. A current trend has been to attempt to reduce the changeover times and provide for increased flexibility in manufacturing facilities such that multiple vehicle body architectures may be produced in a single vehicle manufacturing facility.

It would be desirable to develop a multi-architecture flexible assembly structure wherein flexibility, efficiency, and capital equipment utilization are maximized and tooling changes and switchover downtime are minimized.

### SUMMARY OF THE INVENTION

Consistent and consonant with the present invention, a multi-architecture flexible assembly structure wherein flexibility, efficiency, and capital equipment utilization are maximized and tooling changes and switchover downtime are minimized, has surprisingly been discovered.

The multi-architecture flexible assembly structure comprises: a first station having a loading structure to load components to the first station; a second station having at least one work fixture to convert the components into a finished assembly; a third station having an unloading structure to unload the finished assembly from the third station; a first transfer device to transfer the components from the first station to the second station; and a second transfer device to transfer the finished assembly from the second station to the third station, wherein the loading structure, the at least one work fixture, the first transfer device, and the second transfer device are programmable to facilitate production of at least two distinct finished assemblies using the same loading structure, the at least one work fixture, the first transfer device, and the second transfer device. In the following description, the components are sheet metal panels and the finished assemblies are used in vehicles.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic perspective view of a multi-architecture flexible assembly structure in accordance with the present invention and showing a tool base in a first position;

FIG. 2 is a schematic perspective view of the multi-architecture flexible assembly structure of FIG. 1 showing the tool base in a second position;

FIG. 3 is a schematic perspective view of a second embodiment of the present invention illustrating a multi-architecture flexible assembly structure and showing a tool base in a first position;

FIG. 4 is a schematic perspective view of the multi-architecture flexible assembly structure of FIG. 3 showing the tool base in a second position; and

FIG. 5 is a schematic perspective view of an alternative embodiment of a third station of a multi-architecture flexible assembly structure in accordance with the present invention.

### DESCRIPTION OF THE PREFERRED EMBODIMENT

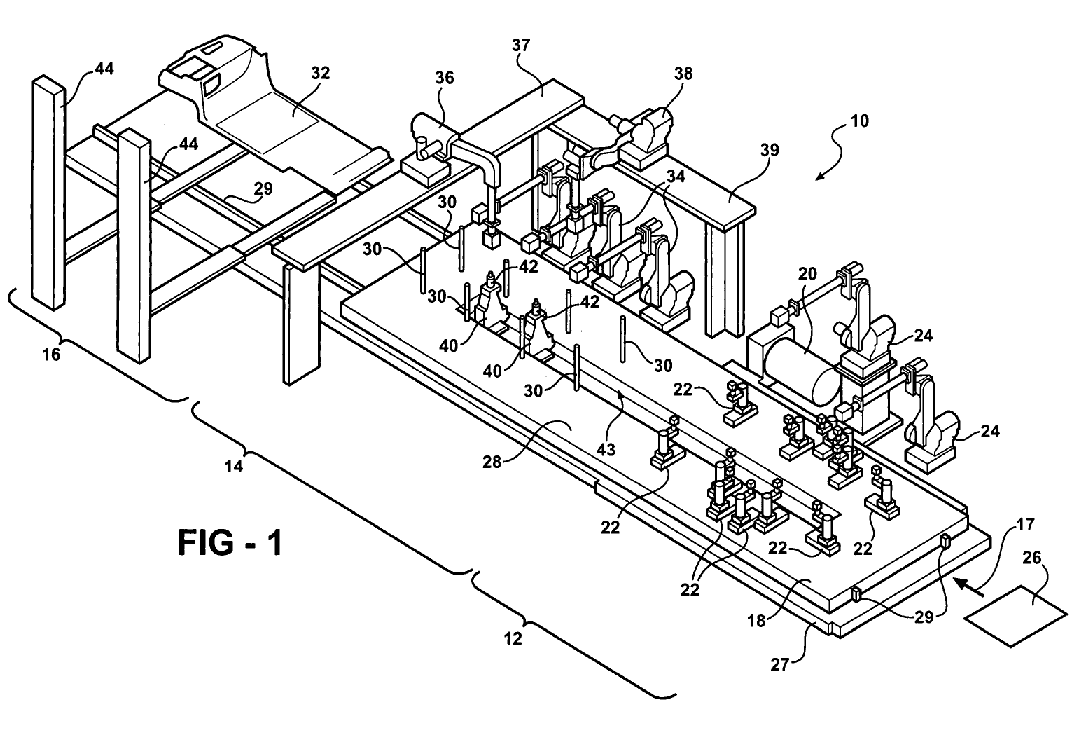

Referring now to FIG. 1, there is shown generally at 10 a schematic perspective view of a multi-architecture flexible assembly structure in accordance with the present invention. The multi-architecture flexible assembly 10 has a first station 12, a second station 14, and a third station 16 aligned in a direction of movement indicated by an arrow 17.

The first station or loading station 12 has a first linearly indexable transfer device or tool base 18 driven by a linear drive 20. A plurality of programmable flexible locating and clamping units 22 is mounted on the first tool base 18. An example of one type of programmable locating and clamping unit 22 is shown and described in assignee's commonly owned U.S. patent application Ser. No. 09/738,399, the contents of which are hereby incorporated by reference. The first station 12 also includes a plurality of floor mounted material handling robots or loading structures 24. The robots 24 load components 26, such as sheet metal panels, as desired to the flexible locating and clamping units 22 on the first tool base 18. Additional manufacturing processes may be located prior to the first station 12 as desired to pre-assemble or otherwise prepare the components 26 to be received by the first station 12. Work fixtures, as herein described, may be positioned at the first station 12 as desired to conduct work processes on the components 26 at the first station 12. The base 18 is supported by a support surface 27 such as a building floor or a platform.

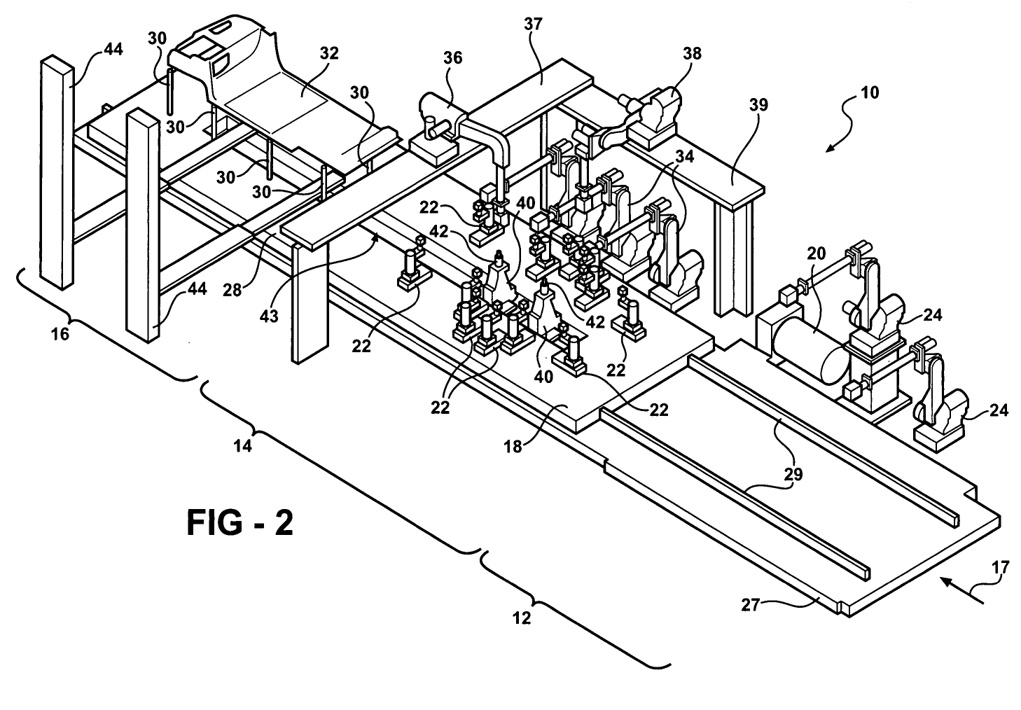

A second linearly indexable transfer device or tool base 28 is linked to the first tool base 18, and is driven by the same linear drive 20 for simultaneous movement. The bases 18 and 28 can be integral, as shown, or separate and are movable together in the direction 17 on a pair of rails 29 attached to the support surface 27. A plurality of rest fixtures 30 mounted on the base 28 is provided to support and transfer a finished product 32 such as a vehicle assembly shown in the third station 16. The rest fixtures 30 may also include a lifting fixture or apparatus (not shown) for lifting and holding the assembly 32 stationary when the first tool base 18 and the second tool base 28 are indexed during the production cycle, discussed in more detail below. The second tool base 28 is positioned in the second station 14 when the first tool base 18 is positioned in the first station 12. When the first tool base 18 is positioned in the second station 14, the second tool base 28 will be positioned in the third station 16, as shown in FIG. 2. It is understood that the first tool base 18 and the second tool base 28 could be used in a non-linked format and indexed separately without departing from the scope and spirit of the invention.

The second station or assembly station 14 has work fixtures including, for example, a plurality of floor mounted welding robots 34, an overhead pogo weld robot 36 mounted on a beam 37, an overhead material handling robot 38 mounted on a beam 39, and a plurality of programmable flexible manipulators 40. Lower electrodes 42 for the pogo weld robot 36 are mounted on the programmable flexible manipulators 40. Examples of the pogo weld robot 36 are shown and described in assignee's commonly owned U.S. Pat. Nos. 6,621,036 and 6,429,397, the contents of which are hereby incorporated by reference. Other work fixture types may be used as desired. A slot 43 is formed in the bases 18 and 28 to receive the manipulators 40 that are fixedly mounted on the support surface 27.

In the embodiment shown, the third station 16 is an unload station. It is understood that additional stations having tooling and/or assembly operations can be added prior to, on, or after the third station 16 as desired without departing from the scope and spirit of the invention. The second tool base 28 is positioned in the third station 16 (see FIG. 2) during an unloading operation where the vehicle assembly 32 is removed from the second tool base 28 and transferred for shipping or to another processing station. An unloading structure or a transfer structure 44 is provided at the third station 16.

In operation, at the start of a production cycle, the first tool base 18 is positioned in the first station 12, and the second tool base 28 is positioned in the second station 14. An appropriate program is loaded in each of the respective controllers for the programmable locating and clamping units 22, the floor mounted welding robots 34, the overhead mounted pogo weld robot 36, the overhead fixed mounted material handling robot 38, and the programmable flexible manipulators 40 for a particular body style of the vehicle assembly 32. Responsive to the program, the programmable locating and clamping units 22 are automatically positioned in locations corresponding to desired locating and clamping positions of the incoming components 26. The components 26 are loaded to the programmable locating and clamping units 22 by the robots 24, or can be manually loaded.

Once the load cycle is complete, the first tool base 18 is caused to move linearly on the rails 29 to the second station 14, as illustrated in FIG. 2. The components 26 are securely held by the programmable locating and clamping units 22 during the transfer operation. When the first tool base 18 is positioned at the second station 14, the floor mounted welding robots 34 and the overhead pogo welding robot 36 in conjunction with the flexible manipulators 40 perform welding on the components 26 to create the vehicle assembly 32. After the first weld cycle is complete, the vehicle assembly 32 is unclamped and the overhead fixed mounted material handling robot 38 removes the vehicle assembly 32 from the first tool base 18.

To begin the next cycle, the empty first tool base 18 and the empty second tool base 28 are caused to return to the first station 12 and the second station 14, respectively. Upon the return of the first tool base 18 to the first station 12, the next loading cycle as described above commences. At the second station 14, the floor mounted welding robots 34 can perform additional spot welds while the assembly 32 is held by the fixed mounted material handling robot 38. Once the second weld cycle in the second station 14 is complete, which typically coincides with the conclusion of the next load cycle in the first station 12, the fixed mounted material handling robot 38 deposits the completed vehicle assembly 32 on the second tool base 28. The first tool base 18 and the second tool base 28 are caused to index, moving the components 26 on the first tool base 18 to the second station 14, and the vehicle assembly 32 on the second tool base 28 to the third station 16 (FIG. 2). The transfer structure 44 unloads the vehicle assembly 32 from the third station 16 and transfers the vehicle assembly 32 to a separate conveyance system for subsequent assembly processes. The cycle then repeats as described above.

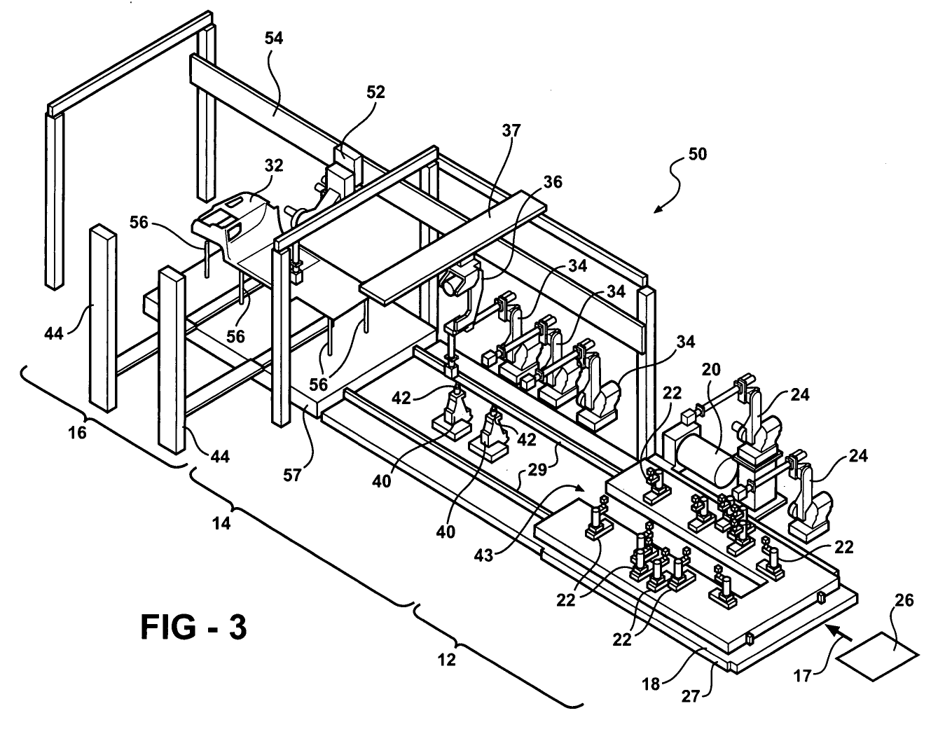

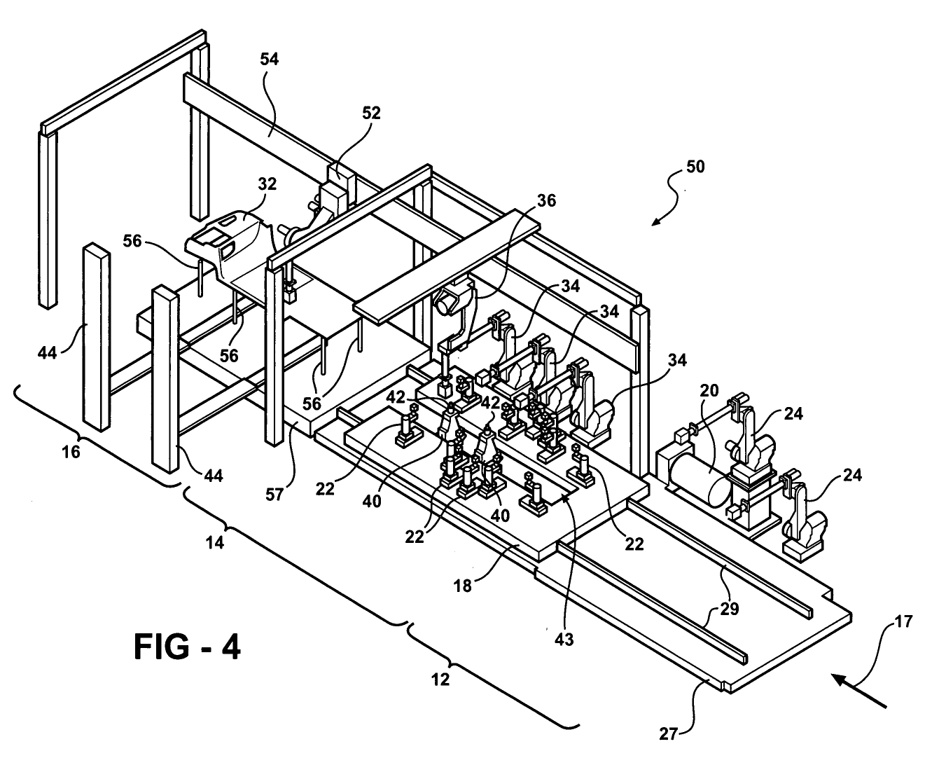

In FIG. 3, there is shown generally at 50 a schematic perspective view of a second embodiment of a multi-architecture flexible assembly structure in accordance with the present invention. Like structures from FIGS. 1 and 2 are shown in FIGS. 3 and 4 with the same reference numerals for clarity. The multi-architecture flexible assembly 50 has the first station 12, the second station 14, and the third station 16.

The first station or loading station 12 of the second embodiment includes the first linearly indexable transfer device or tool base 18 driven by the linear drive 20. The programmable flexible locating and clamping units 22 are mounted on the first tool base 18. The first station 12 also includes the material handling robots or loading structures 24. The robots 24 load the components 26 as required to the flexible locating and clamping units 22 on the first tool base 18.

The second station or assembly station 14 has work fixtures including, for example, the floor mounted welding robots 34, the overhead mounted pogo weld robot 36, and the programmable flexible manipulators 40. The lower electrodes 42 for the pogo weld robot 36 are mounted on the programmable flexible manipulators 40. The second station 14 also includes a second transfer device or rail-mounted robot 52 which replaces the fixed mounted material handling robot 38 of the first embodiment. The rail-mounted robot 52 is capable of being indexed linearly from the second station 14 to the third station 16 along a rail 54 parallel to the direction arrow 17. Other work fixtures may be used as desired.

The third station 16 is an unload station. It is understood that additional stations having tooling operations can be added as desired and that additional fixtures, including work fixtures, may be added to the third station 16 without departing from the scope and spirit of the invention. A plurality of holding fixtures 56 is provided on a base 57 to support the finished vehicle assembly 32. The unloading structure or transfer structure 44 is provided at the third station 16.

In operation, at the start of the production cycle, the first tool base 18 is positioned in the first station 12. An appropriate program is loaded in each of the respective controllers for the programmable locating and clamping units 22, the floor mounted welding robots 34, the overhead mounted pogo weld robot 36, the rail-mounted robot 52, and the programmable flexible manipulators 40 for a particular body style of the vehicle assembly 32. Responsive to the program, the programmable locating and clamping units 22 are automatically positioned in locations corresponding to desired locating and clamping positions of the incoming components 26. The components 26 are loaded to the programmable locating and clamping units 22 by the robots 24, or can be manually loaded.

Once the load cycle is complete, the first tool base 18 is caused to move linearly to the second station 14, as illustrated in FIG. 4. The components 26 are securely held by the programmable locating and clamping units 22 during the transfer operation. When the first tool base 18 is positioned at the second station 14, the floor mounted welding robots 34 and the overhead pogo welding robot 36 in conjunction with the flexible manipulators 40 perform welding on components 26 to create the vehicle assembly 32. After the first weld cycle is complete, the rail mounted robot 52 clamps onto the vehicle assembly 32 which is then unclamped from the flexible locating and clamping units 22 of the first tool base 18.

To begin the next cycle, the empty first tool base 18 is returned to the first station 12. Upon the return of the first tool base 18 to the first station 12, the next loading cycle as described above commences. At the second station 14, the floor mounted welding robots 34 can perform additional spot welds while the vehicle assembly 32 is held by the rail-mounted robots 52. Once the second weld cycle in the second station 14 is complete, which coincides with the conclusion of the next load cycle in the first station 12, the rail-mounted robot 52 indexes to the third station 16 and deposits the vehicle assembly 32 on the holding fixtures 56. Simultaneously, the first tool base 18 is caused to index, moving the components 26 on the first tool base 18 to the second station 14. The transfer structure 44 unloads the vehicle assembly 32 from the holding fixtures 56 of the third station 16 and transfers the vehicle assembly 32 to a separate conveyance system for subsequent assembly processes. The rail-mounted robot 52 and the first tool base 18 return to second station 14 and the first station 12, respectively. The cycle then repeats as described above.

As shown and described, the flexible assembly structures 10, 50 can accommodate a wide variety of dissimilar styles and platforms of vehicle architectures. The various vehicle styles and architectures are accommodated through software programming of the flexible locating and clamping units 22, the flexible manipulators 40 used with the pogo welder 36, and the robots 24, 52. While the components 26 and the assembly 32 were described above in terms of assembling vehicles, the flexible assembly structures 10, 50 can be used assemble other types of products.

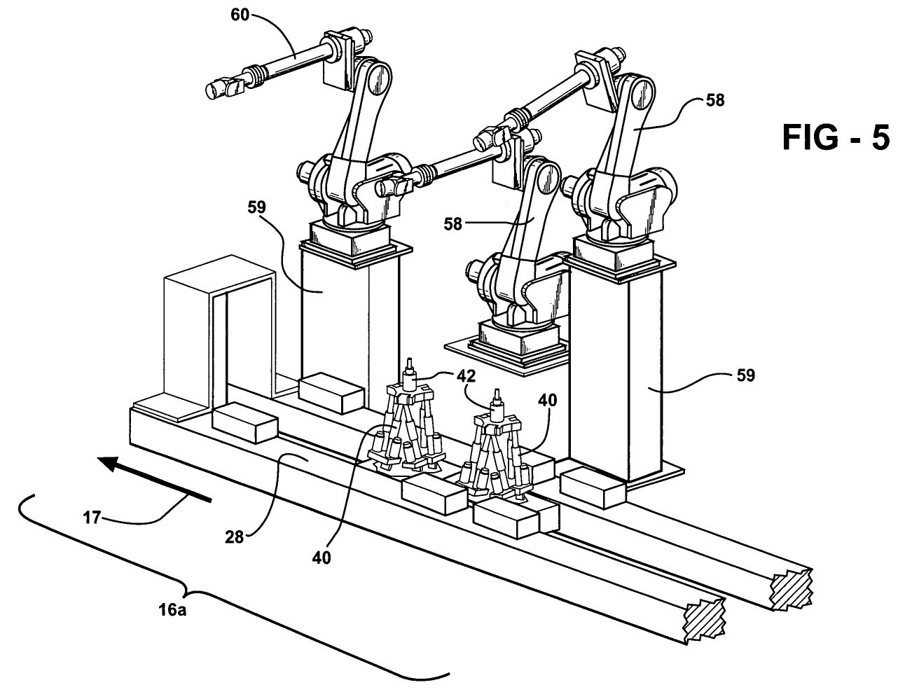

An alternative embodiment of the third station is indicated generally at 16a in FIG. 5. The third station 16a is an unloading and re-spotting station that includes a plurality of welding robots 58. The robots 58 may be one or any of the floor mounted welding robot 34, the pogo welding robot 36, and the programmable flexible manipulator 40 as shown in FIGS. 1-4. The welding robots 58, though shown as mounted on pedestals 59, may be floor-mounted, rail-mounted, or the like. The third station 16a also includes at least one material handling robot 60. The material handling robot 60 may be one or any of the material handling robots 24, the fixed mounted material handling robot 38 of FIGS. 1-2 and the rail-mounted robot 52 of FIGS. 3-4. The third station 16a receives a workpiece, such as the assembly 32, from the second station 14, where the assembly 32 is held in place by the material handling robot 60. At the third station 16a, the welding robots 58 can perform additional spot welds while the assembly 32 is held in place in the second tool base 28 by the material handling robot 60. After the additional spot welds are performed by the welding robots 58, the material handling robot 60 is operable to move the assembly 32, for transfer for shipping or to another processing station.

From the foregoing description, one ordinarily skilled in the art can easily ascertain the essential characteristics of this invention and, without departing from the spirit and scope thereof, can make various changes and modifications to the invention to adapt it to various usages and conditions.

1. A multi-architecture flexible assembly structure comprising:
a first station having a loading structure to load components to said first station;
a second station having at least one work fixture to convert the components into a finished assembly;
a third station having an unloading structure to unload the finished assembly from said third station;
a first transfer device to transfer the components from said first station to said second station; and
a second transfer device to transfer the finished assembly from said second station to said third station, wherein said loading structure, said at least one work fixture, said first transfer device, and said second transfer device are programmable to facilitate production of at least two distinctly different ones of the finished assembly.

2. The assembly structure according to claim 1, wherein said loading structure is at least one material handling robot for loading the components.

3. The assembly structure according to claim 1, wherein the at least one work fixture is one of a floor mounted welding robot, a pogo welding robot, an overhead mounted material handling robot, and a programmable flexible manipulator.

4. The assembly structure according to claim 1, wherein said first transfer device includes a moveable tool base having at least one flexible locating and clamping unit for receiving the components.

5. The assembly structure according to claim 4, wherein the tool base is linearly indexed between said first and second stations.

6. The assembly structure according to claim 5, including at least one rail upon which said tool base is indexed.

7. The assembly structure according to claim 1, wherein said first transfer device includes a first moveable tool base having at least one flexible locating and clamping unit for receiving the components and wherein said second transfer device includes a second moveable tool base having at least one rest fixture disposed thereon for receiving the finished assembly.

8. The assembly structure according to claim 7, wherein said first and second tool bases are linked for simultaneous movement.

9. The assembly structure according to claim 1, wherein said second transfer device is a rail-mounted robot linearly indexable between said second station and said third station.

10. The assembly structure according to claim 1, wherein said third station includes at least one work fixture for spot-welding the finished assembly.

11. A multi-architecture flexible assembly structure comprising:
a loading station having a loading structure for loading sheet metal panels on said loading station;
an assembly station having at least one of a floor mounted welding robot, a pogo welding robot, an overhead fixed mounted material handling robot, and a programmable flexible manipulator for assembling the sheet metal panels into a vehicle assembly;
an unloading station having an unloading structure for unloading the vehicle assembly from said unloading station;
a first tool base having at least one flexible locating and clamping unit for receiving the sheet metal panels from said loading structure and transferring the sheet metal panels from said loading station to said assembly station; and
a transfer device for receiving the vehicle assembly from said assembly station and transferring the vehicle assembly to said unloading station, wherein the assembly structure is programmable to facilitate production of at least two distinctly different ones of the vehicle assembly.

12. The assembly structure according to claim 11, wherein said loading structure is a material handling robot.

13. The assembly structure according to claim 11, wherein said first tool base is a linear indexing tool base.

14. The assembly structure according to claim 11, wherein said transfer device is a second tool base having at least one rest fixture disposed thereon for receiving the vehicle assembly.

15. The assembly structure according to claim 14, wherein said first tool base and said second tool base are linked for simultaneous movement.

16. The assembly structure according to claim 11, wherein said transfer device is a rail-mounted robot linearly indexable between said assembly station and said unloading station.

17. The assembly structure according to claim 11, wherein said unloading station includes at least one of a floor mounted welding robot, a pogo welding robot, and a programmable flexible manipulator for spot-welding the vehicle assembly and at least one of material handling robot, an overhead fixed mounted material handling robot, and a rail-mounted robot for unloading the vehicle assembly from said unloading station.

18. A method of producing different styles of finished assemblies with a single assembly structure, the method comprising the steps of:
a) providing a loading station having a loading structure to load sheet metal panels to the loading station;
b) providing an assembly station having at least one work fixture;
c) providing an unloading station having an unloading structure to unload a finished assembly from the unloading station;
d) programming at least one controller to control operation of the loading structure and the at least one work fixture to assemble the sheet metal panels into a selected style finished assembly;
e) loading sheet metal panels to the loading station using the loading structure;
f) transferring the sheet metal panels from the loading station to the assembly station;
g) operating the at least one work fixture to assemble the sheet metal panels into the selected style finished assembly;
h) transferring the selected style finished assembly from the assembly station to the unloading station; and
i) unloading the selected style finished assembly from the unloading station.

19. The method according to claim 19, wherein said step a) includes providing a moveable tool base having at least one flexible locating and clamping unit as the loading structure.

20. The method according to claim 19, wherein said step b) includes providing the at least one work fixture as one of a floor mounted welding robot, a pogo welding robot, an overhead fixed mounted material handling robot, and a programmable flexible manipulator.
